(19) United States
(12) Patent Application Publication
(10) Pub. No.: US 2008/0233975 A1
(43) Pub. Date: Sep. 25, 2008

(54) Paging method and apparatus for heterogeneous wireless network system

(75) Inventors: Seung-Hee Kim, Daejeon (KR); Gyung-Chul Shin, Daejeon (KR); Dae-Sik Kim, Daejeon (KR); Jin-Sung Cho, Suwon-si (KR); Dae-Young Kim, Yongin-si (KR)

Correspondence Address: STAAS & HALSEY LLP, SUITE 700, 1201 NEW YORK AVENUE, N.W., WASHINGTON, DC, 20005, US

(73) Assignees: Electronics and Telecommunications Research Institute, Daejeon (KR); Industry Academic Cooperation Foundation of KyungHee University, Yongin-si (KR)

(21) Appl. No.: 11/987,577

(22) Filed: Nov. 30, 2007

(30) Foreign Application Priority Data
Mar. 19, 2007 (KR) 10-2007-0026667

(51) Int. Cl. H04Q 7/20

(52) U.S. Cl. 455/458

(57) ABSTRACT

In a heterogeneous wireless network system, a apparatus for notifying a mobile station of existence of traffic from a network to which the mobile station is not connected receives an identifier of the mobile station from the network to which the mobile station is not connected. The apparatus checks the network to which the mobile station having the same identifier as the received is connected, and transmits a signal for indicating existence of traffic to the mobile station by using the network's interface.

### CROSS-REFERENCE TO RELATED APPLICATION

This application claims priority to and the benefit of Korean Patent Application No. 10-2007-0026667 filed in the Korean Intellectual Property Office on Mar. 19, 2007, the entire contents of which are incorporated herein by reference.

### BACKGROUND OF THE INVENTION

(a) Field of the Invention

The present invention relates to a paging method and apparatus in a heterogeneous wireless network system.

This work was supported by the IT R&D program of MIC/IITA [2006-S-003-01, Research on service platform for the next generation mobile comm].

(b) Description of the Related Art

In general, a 3G mobile communication system for providing a service from a circuit network such as the CDMA2000 or UMTS detects the location of a mobile station through a home location register (HLR) and a visitor location register (VLR), and notifies a 3G voice call receipt so as to page the mobile station. A system that provides a service on the packet network such as the IEEE 802.11 wireless local area network (WLAN) and the 2.3 GHz portable Internet registers the location of a mobile station to a home agent by using a mobile IP and thereby notifies of IP packet data receipt. The circuit network for the 3G voice call service is different from the packet network for the IP packet data service. Therefore, a software defined radio (SDR) mobile station that is accessible to various heterogeneous wireless networks by changing module-type software without changing hardware cannot receive the 3G voice call service since the SDR mobile station cannot receive a received signal for a 3G voice call when the 3G voice call is generated by the circuit network while the SDR mobile station accesses the packet network and receives an IP packet data service.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a paging method for a mobile station to receive a 3G voice call while receiving a packet data service, and a paging apparatus.

In one aspect of the present invention, a paging method in a system having a plurality of networks, the paging method for informing that there is traffic toward a mobile station from a network to which the mobile station is not accessed in a system having a plurality of networks includes receiving an identifier of the mobile station from the network to which the mobile station is not connected, checking the network to which the mobile station having the same identifier as the received identifier is connected, and transmitting a signal for notifying existence of the traffic to the mobile station by using an interface of the checked network.

In another aspect of the present invention, a apparatus for paging until a mobile station receives traffic that is generated from a network to which the mobile station is not connected in a system including a plurality of networks includes a mapping manager for receiving an identifier of the mobile station from a network to which the mobile station is not connected and checking the network to which the mobile station having the same identifier as the received identifier is connected, and a signal transmitter for transmitting a signal for notifying generation of the traffic to the mobile station by using a communication protocol of the checked network.

In another aspect of the present invention, a method for a mobile station connected to a first network to receive information for indicating existence of traffic from a second network to which the mobile station is not connected through a system for managing the first and second networks includes transmitting a first message including information corresponding to the type of the connected first network and receiving a second message that is transmitted according to an interface of the connected first network, wherein the second message includes information on the traffic.

### BRIEF DESCRIPTION OF THE DRAWINGS

FIG. 1 shows brief diagram for a heterogeneous wireless network system according to an exemplary embodiment of the present invention.

FIG. 2 shows a flowchart for a paging method in a heterogeneous wireless network system according to an exemplary embodiment of the present invention.

FIG. 3A shows a SIP (Session Initiation Protocol) message used for an embodiment of the present invention.

FIG. 3B shows a SIP INVITE message of the SIP message.

FIG. 4 shows a block diagram for a SSM according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims which follow, unless explicitly described to the contrary, the word “comprising” and variations such as “comprises” will be understood to imply the inclusion of stated elements but not the exclusion of any other elements. Also, the terms “unit”, “apparatus”, and “module” in the present specification represent a unit for processing a predetermined function or operation, which can be realized by hardware, software, or a combination of hardware and software.

A paging method and an apparatus thereof in a heterogeneous wireless network system according to an exemplary embodiment of the present invention will now be described in detail with reference to the accompanying drawings. The term “IP packet data” represents traffic that is provided for a service on the packet network, and the term “voice call” indicates traffic that is provided for a service on the circuit network.

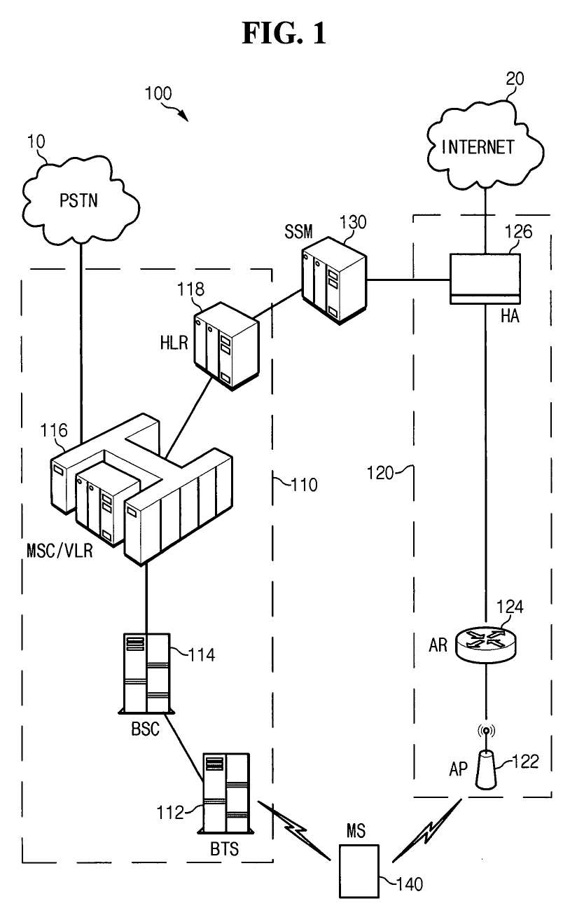

FIG. 1 shows brief diagram for a heterogeneous wireless network system according to an exemplary embodiment of the present invention.

As shown in FIG. 1, the heterogeneous wireless network system 100 includes a circuit network system 110, a packet network system 120, a service status manager (SSM) 130, and a mobile station 140. In FIG. 1, a CDMA2000 mobile communication system that is a 3G mobile communication system lo connected to the public switched telephone network (PSTN) 10 is illustrated for the circuit network system 110, and an IEEE 802.11 wireless local area network (WLAN) system connected to the Internet is illustrated for the packet network system 120, and it is also possible to apply another communication system other than the above-noted systems and additionally connect another communication system to the system. The circuit network system 110 includes a base transceiver system (BTS) 112, a base station controller (BSC) 114, a mobile switching center/visitor location register (MSCNLR) 116, and a home location register (HLR) 118, and the packet network system 120 includes an access point (AP) 122, an access router (AR) 124, and a home agent (HA) 126.

The BTS 112 in the circuit network system 110 performs radio access to the mobile station 140. The BSC 114 processes the voice call service provided between the BTS 112 and the MSCNLR 116, and manages and controls the BTS 112. The MSCNLR 116 performs a circuit switching process between subscribers, an in/out relay process, a handoff process, and a roaming process, and manages a VLR database. Also, the MSC/VLR 116 senses the case in which a mobile station of a different system enters the area covered by the MSC/VLR 116, and roams the mobile station with the different system. The HLR 118 manages the subscriber's state, statistics, and various types of service information in addition to current location information of the mobile station 140.

The AP 122 is connected to the AR 124 in the packet network system 120, and performs a wired/wireless access between the mobile station 140 and the AR 124, which is similar to the function of the BTS 112 of the circuit network system 110. The AR 124 processes the IP packet data transmitted between the Internet 20 and the mobile station 140, which is similar to the function of the BSC 114 of the circuit network system 110. When a subscriber moves to another system, the HA 126 tunnels the IP packet data targeting the subscriber to the area of the other system, which is similar to the function of the MSC/VLR is 116 of the circuit network system 110.

The SSM 130 is connected between the HLR 118 of the circuit network system 110 and the HA 126 of the packet network system 120, and manages wireless access state information on the network accessed by the mobile station 140. Also, when a voice call to be transmitted to the mobile station 140 connected to the packet network system 120 is generated in the circuit network system 110, a receipt of the voice call is notified to the mobile station 140 by using the SIP protocol that is a communication protocol of the packet network system 120 connected by the mobile station 140.

The mobile station 140 can access various wireless networks by changing a software module of a single hardware platform, and can provide a packet data service and a voice call service to the user in the heterogeneous wireless network system 100 in which the circuit network system 110 and the packet network system 120 coexist. On detecting a receipt of the voice call by the SSM 130 while being connected to the packet network system 120, the mobile station 140 receives a voice call service from the circuit network system 110 by loading a software module for the interface with the circuit network system 110.

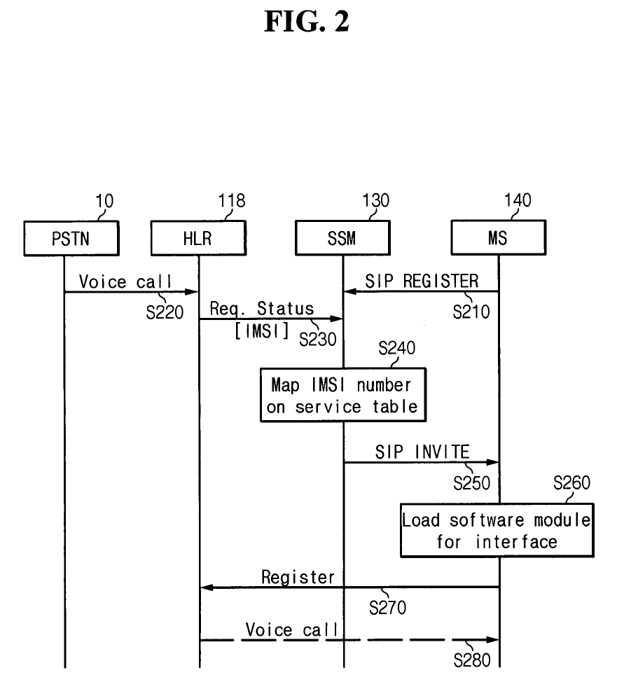

A paging method for the mobile station 140 to receive a voice call when the voice call is generated in the circuit network system 110 while the mobile station 140 connected to the packet network system 120 receives packet data will now be described referring to FIG. 2. The mobile station 140 is assumed in FIG. 2 to be connected to the packet network system 120, and the paging process is started when a voice call is generated by the circuit network system 110.

FIG. 2 shows a flowchart for a paging method in a heterogeneous wireless network system according to an exemplary embodiment of the present invention.

As shown in FIG. 2, when the mobile station 140 is connected to the packet network system 120, the mobile station 140 transmits a SIP register (SIP REGISTER) message including wireless access state information on the network connected by the mobile station 140 to the SSM 130 (S210). The SIP register (SIP REGISTER) message includes an international mobile station identity (IMSI) number of the mobile station and the wireless access state information.

On receiving the SIP register (SIP REGISTER) message, the SSM 130 registers the IMSI number of the mobile station 140 having transmitted the SIP register (SIP REGISTER) message and the wireless access state information into a service table.

Through the register process, the wireless access state information of the mobile station 140 is added or updated to the service table.

On receiving the voice call from the PSTN 10, the HLR 118 transmits a state information request message (Req. Status) including the IMSI number of the mobile station 140 to the SSM 130 (S220-S230).

The SSM 130 maps the IMSI (International Mobile Station Identify) number of the mobile station 140 included in the state information request message (Req. Status) received from the HLR 118 on the service table (S240). The SSM 130 checks that the network connected by the mobile station 140 is a packet network through the mapping of the IMSI number on the service table, sets signal information for notifying the packet network system 120 of generation of a voice call to the SIP INVITE message, and transmits the SIP INVITE message to the mobile station 140 (S250).

On receiving the SIP INVITE message, the mobile station 140 detects that a voice call is received by the circuit network system 110, and loads a software module for the interface of the circuit network system 110 (S260). When the loading of the software module is finished, the mobile station 140 registers to the HLR 118 and receives a voice call service (S270-280).

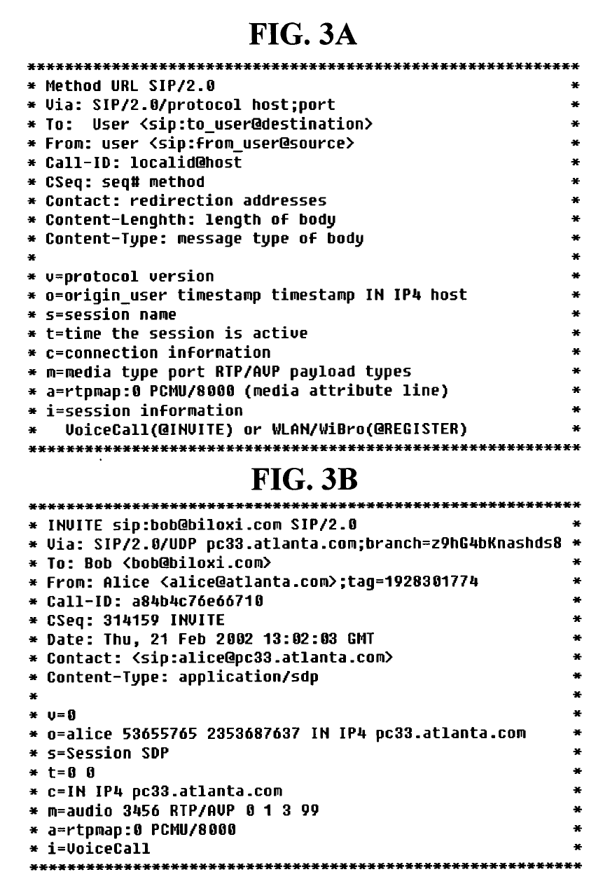

FIG. 3A shows a SIP (Session Initiation Protocol) message used for an embodiment of the present invention, and FIG. 3B shows a SIP INVITE message of the SIP message.

As shown in FIG. 3A, the “i” option for indicating session information from among the options of the SIP message is used to notify the mobile station 140 of generation of a voice call or register wireless access state information for the network connected by the mobile station 140. That is, as shown in FIG. 3B, a “VoiceCall” is assigned to the “i” option to set traffic information in the SIP INVITE message, the mobile station 140 having received the SIP INVITE message detects generation of a voice call from the “VoiceCall” set to the “i” option. In a like manner, the “WLAN” is assigned to the “i” option to set information on the connected network in the SIP REGISTER message, and the SSM 130 having received the SIP REGISTER message checks that the network currently connected by the mobile station 140 is a packet network from the “WLAN” set to the “i” option. Appropriate storage such as RAM is provided is in the mobile station to store the messages of FIGS. 3A and 3B.

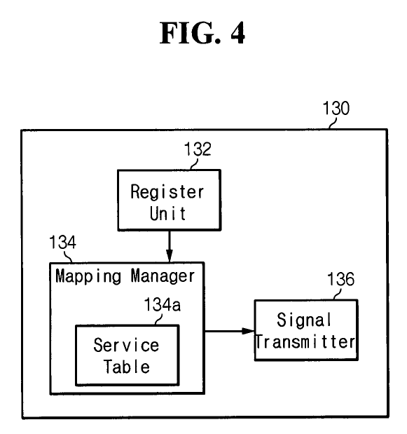

An operation of the SSM 130 shown in FIG. 2 will now be described referring to FIG. 4. FIG. 4 shows a block diagram for an SSM according to an exemplary embodiment of the present invention.

As shown in FIG. 4, the SSM 130 includes a register unit 132, a mapping manager 134, and a signal transmitter 136. The register unit 132 registers the IMSI number and the wireless access state information of the mobile station 140 from the SIP REGISTER message including the wireless access state information received from the mobile station 140 to the service table 134a.

The mapping manager 134 manages the service table 134a, and maps the IMSI number of the mobile station 140 included in a SIP REGISTER message in the service table 134a to check the network connected by the mobile station 140 when receiving the SIP REGISTER message from the circuit network system 110.

The signal transmitter 136 sets signal information for notifying generation of a voice call to the SIP INVITE message that is the checked network's communication standard, and transmits the SIP INVITE message to which signal information is set to the mobile station 140.

The above-described embodiments can be realized through a program for realizing functions corresponding to the configuration of the embodiments or a recording medium for recording the program in addition to through the above-described apparatus and/or method, which is easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

According to the exemplary embodiment of the present invention, the mobile station that is accessible to various wireless networks can receive a voice call service when the voice call service is generated from another network while accessing a packet network and receiving a packet data service.

1. A paging method in a system having a plurality of networks, the paging method for informing that there is traffic toward a mobile station from a network to which the mobile station is not accessed in a system having a plurality of networks, the paging method comprising:
receiving an identifier of the mobile station from the network to which the mobile station is not connected;
checking the network to which the mobile station having the same identifier as the received identifier is connected; and
transmitting a signal for notifying existence of the traffic to the mobile station by using an interface of the checked network.

2. The paging method of claim 1, wherein the network to which the mobile station is not connected is a circuit network, and the network to which the mobile station is connected is a packet network.

3. The paging method of claim 1, wherein
the signal for notifying receipt of the traffic is transmitted by using a session initiation protocol (SIP) message.

4. The paging method of claim 3, wherein
the signal is transmitted by setting information on the traffic to an option field for indicating session information in the session initiation protocol (SIP) message.

5. The paging method of claim 1, further comprising:
receiving an identifier and state information of the connected network from the mobile station.

6. The paging method of claim 5, wherein the receiving the identifier and the state information is performed by using a session initiation protocol (SIP) message.

7. The paging method of claim 6, wherein
the state information is received by setting information for indicating a type of the network to which the mobile station is connected to an option field for indicating session information in the SIP message.

8. The paging method of claim 1, wherein
the identifier is an international mobile station identity (IMSI) number.

9. A apparatus for paging until a mobile station receives traffic that is generated from a network to which the mobile station is not connected in a system including a plurality of networks, the apparatus comprising:
a mapping manager for receiving an identifier of the mobile station from a network to which the mobile station is not connected, and checking the network to which the mobile station having the same identifier as the received identifier is connected; and
a signal transmitter for transmitting a signal for notifying generation of the traffic to the mobile station by using a communication protocol of the checked network.

10. The apparatus of claim 9, further comprising a register unit for registering an identifier of the mobile station and state information of the network to which the mobile station is connected.

11. The apparatus of claim 10, wherein
the network to which the mobile station is not connected is a circuit network, and the network to which the mobile station is connected is a packet network.

12. A method for a mobile station connected to a first network to receive information for indicating existence of traffic from a second network to which the mobile station is not connected through a system for managing the first and second networks, the method comprising:
transmitting a first message including information corresponding to a type of the connected first network; and
receiving a second message that is transmitted according to an interface of the connected first network, wherein the second message includes information on the traffic.

13. The method of claim 12, wherein
the second message is a session initiation protocol (SIP) message, and
an option field for indicating session information of the SIP message includes information on the traffic and information on the type of the first network.

14. The method of claim 13, wherein
the first network is a packet network, and the second network is a circuit network.

15. The method of claim 12, further comprising:
detecting existence of the traffic from the received second message; and
accessing the second network and receiving the traffic.

16. A mobile station storage for controlling the mobile station, comprising:
a paging message storage, comprising:
a mobile station identifier field storing a mobile station identifier of the mobile station; and
a session identifier protocol session invite message field containing voice call session information of a page for the mobile station.
